(19) United States
(12) Patent Application Publication
(10) Pub. No.: US 2010/0100739 A1
(43) Pub. Date: Apr. 22, 2010

(54) SYSTEM AND METHOD FOR SECURE COMMUNICATION, AND A MEDIUM HAVING COMPUTER READABLE PROGRAM EXECUTING THE METHOD

(75) Inventor: Hong-Kyu Park, Anyang (KR)

Correspondence Address: CANTOR COLBURN, LLP, 20 Church Street, 22nd Floor, Hartford, CT, 06103, US

(73) Assignee: ALLAT CORPORATION, Seoul (KR)

(21) Appl. No.: 12/532,028

(22) PCT Filed: May 10, 2007
(86) PCT No.: PCT/KR2007/002320

§ 371 Date: Sep. 18, 2009

(30) Foreign Application Priority Data
Mar. 22, 2007 (KR) 10-2007-0028229

(51) Int. Cl. H04L 9/32; G06F 3/048; H04L 9/08

(52) U.S. Cl. 713/170; 715/738; 380/282

(57) ABSTRACT

A system and a method for a secure communication, and a medium having a computer readable program therefor. The system for a secure communication comprises an identification information extracting unit for extracting identification information from a request message sent from a web browser, and a response message sending unit for sending a response message corresponding to the request message to the web browser when the identification information satisfies a predetermined reference. Since a response message is sent only to a web browser that sends identification information that satisfies a predetermined reference, a secure HTTP communication can be implemented even when session key information is leaked.

### TECHNICAL FIELD

The present disclosure relates to a system and a method for a secure communication, and more particularly, to a method for a secure HTTP communication.

### BACKGROUND ART

A hypertext transfer protocol (HTTP) is a communication standard used on the Internet so as to exchange a text between a web server and a user's internet browser. The HTTP is a communication standard used to exchange a hypertext on the Internet.

The hypertext enables different texts to be referred as one text by inserting a specific keyword between texts and connecting the texts or pictures to each other.

FIG. 1 is a schematic view showing a data flow in an HTTP communication in accordance with the conventional art.

When a user visits a web site on the Internet, processes 1 to 4 are repeated.

Referring to FIG. 1, a request and a response are respectively composed of a header and a body. The header of the request includes a request service, additional information, and additional information relevant to the body. Also, the body of the request includes data inputted on the Internet. The body may not be provided.

The header of the response includes a response code, body information, additional information, and information requiring a specific action to a web browser. Also, the body of the response includes data to be shown on the web browser.

The HTTP is not provided with a session function, thereby implementing a virtual session function by using a cookie, etc. The cookie is stored in the web browser, and is added to the header when being requested.

FIG. 2 is a schematic view showing a communication state between a web browser and a web server by using a cookie.

Referring to FIG. 2, the web server enables the web browser to manage the cookie by adding specific information to the header of the response. The web server simultaneously receives requests of each browser, and additionally implements a session function so as to differentiate each browser from each other. The most commonly used session function is implemented by using the cookie and a memory on the web server.

When the web browser accesses to the web server or logs-in, the web server provides a session key with additional information of ‘Set-Cookie’ by including in the header of the response. Then, the web browser stores the session key having the ‘Set-Cookie’ received from the web server therein. Subsequently, the web browser sends a request message by adding the session key to the ‘Set-Cookie’ included in the header.

The web server extracts the session key from the cookie requested by the web browser, and searches corresponding session information from a session table. The web server may store various information such as log-in information and a user's information in a session.

Session information is stored in the web server, and the web browser has a session key corresponding to a corresponding session. The web browser includes a session key in a specific part of a request message (i.e., a cookie), thereby allowing the web server to search a corresponding session.

However, when the session key information of the request message is leaked, the web server has a difficulty in detecting the leakage. The reason is because the web server performs a response by using the conventional session information even when a key for an already-set session is used by another web browser by duplication.

### DISCLOSURE

### Technical Problem

Therefore, an object of the present disclosure is to provide a system and a method for a secure HTTP communication even when session key information is leaked.

### Technical Solution

To achieve these and other advantages and in accordance with the purpose of the present disclosure, as embodied and broadly described herein, there is provided a system for a secure communication, comprising: an identification information extracting unit; and a response message sending unit. The identification information extracting unit extracts identification information from a request message sent from a web browser, and the response message sending unit sends a response message corresponding to the request message to the web browser when the identification information satisfies a predetermined reference.

Since a response message is sent only to a web browser that sends identification information that satisfies a predetermined reference, a secure HTTP communication can be implemented even when session key information is leaked.

The identification information extracting unit comprises an encryption value extracting unit for extracting an encryption value of the identification information from the request message, and a decoding unit for decoding the extracted encryption value.

Since identification information is sent after being encrypted, it is prevented from being misused.

The decoding may be performed by using an encryption key sent from a web browser, and the encryption key may be encrypted by using a public key of a web server. Accordingly, a secure communication between the web server and the web browser can be more enhanced.

The system for a secure communication may further comprise a program sending unit for sending a computer program including identification information in a request message of a web browser to a terminal where the web browser is executed. Accordingly, a user having no professional knowledge for secure communication can easily utilize the secure communication.

The system for secure communication may further comprise a request message body decoding unit for decoding an encrypted body of the request message sent from the web browser, and may further comprise a response message body encrypting unit for encrypting a body of the response message sent to the web browser. Accordingly, each body of the request message and the response message transceived between the web browser and a web server can be securely maintained.

According to another aspect of the present invention, a system for a secure communication comprises an identification information generating unit, and an identification information inserting unit. The identification information generating unit generates identification information of the request message when the web browser accesses to the web server, and the identification information inserting unit inserts identification information to the request message sent to the web server by the web browser.

Since identification information of each web browser is sent to the web server, the web server sends a response message only to a web browser that sends identification information that satisfies a predetermined reference. Accordingly, a secure HTTP communication can be implemented even when session key information is leaked.

To achieve these and other advantages and in accordance with the purpose of the present disclosure, as embodied and broadly described herein, there is also provided a medium having a computer readable program for executing the system and the method.

### Advantageous Effects

The present invention has the following effects.

Data exchanged on the session between the web server and the web browser is ensured to be valid and to be used only one time.

Even if session key information is leaked, the session is not interrupted since an encryption key value and a session number can not be revealed.

Furthermore, a security communication between the web server and the web browser can be enhanced by refusing a re-use for an already-used request and by preventing a request from being arbitrarily generated.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view showing a data flow in an HTTP communication in accordance with the conventional art;

FIG. 2 is a schematic view showing a communication state between a web browser and a web server by using a cookie;

FIG. 3 is a block diagram schematically showing a usage state of a system for a secure communication according to one embodiment of the present invention;

FIG. 4 is a block diagram schematically showing a system for a secure communication according to one embodiment of the present invention;

FIG. 5 is a block diagram schematically showing a system for a secure communication according to another embodiment of the present invention; and

FIG. 6 is a diagram showing a method for secure communication according to one embodiment of the present invention.

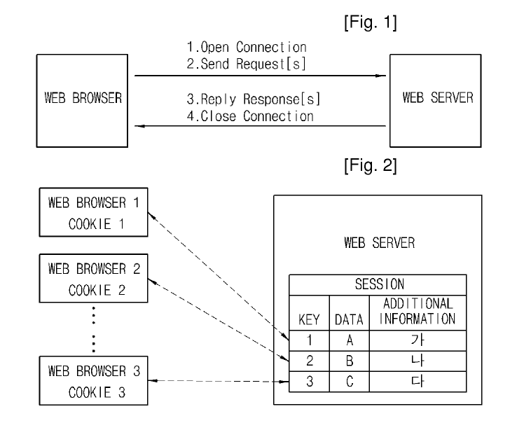

### MODE FOR INVENTION

Reference will now be made in detail to the preferred embodiments of the present disclosure, examples of which are illustrated in the accompanying drawings.

FIG. 3 is a block diagram schematically showing a usage state of a system for a secure communication according to one embodiment of the present invention.

Referring to FIG. 3, a web server 100 and a web browser 300 perform a secure communication via a relay program 200.

The relay program 200 is a program disposed between a web browser and a web server being communication with each other, and contains or verifies necessary information. The relay program may be added to a web browser of a user's terminal, or may be independently implemented from the web browser.

The relay program 200 may be immediately inserted between the web browser and the web server with requiring no additional program.

The relay program 200 inserts verification information into a request message of the web browser thus to send to the web server. Then, the relay program 200 analyzes a response message from the web server, and re-sends a result of the analysis to the web browser.

The system may further perform an encryption process for a body of a request message from the web browser, and perform a decoding process for a response message from the web server.

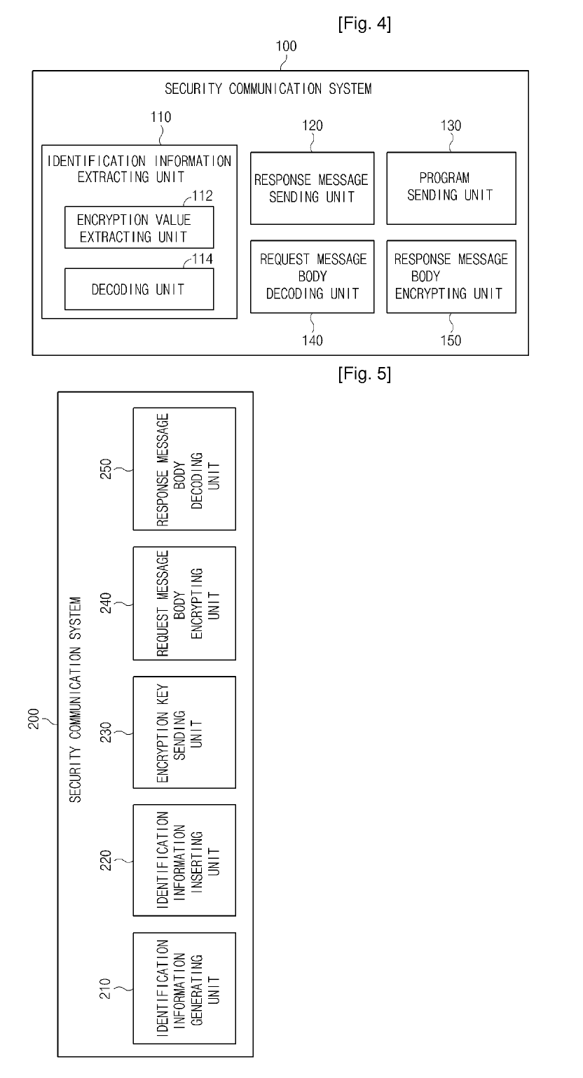

FIG. 4 is a block diagram schematically showing a system for a secure communication according to one embodiment of the present invention.

A system 100 for a secure communication may be implemented as a web server, and comprises an identification information extracting unit 110, a response message sending unit 120, a program sending unit 130, a request message body decoding unit 140, and a response message body encrypting unit 150. The identification information extracting unit 110 includes an encryption value extracting unit 112, and a decoding unit 114.

The identification information extracting unit 110 extracts identification information of a request message sent from a web browser.

The encryption value extracting unit 112 extracts an encryption value of identification information from the request message. Since identification information is sent after being encrypted, it is prevented from being misused.

The decoding unit 114 decodes an extracted encryption value. The decoding is performed by using an encryption key sent from the web browser. Herein, the encryption key may be encrypted by using a public key of a web server. Accordingly, a secure communication between the web server and the web browser can be more enhanced.

The response message sending unit 120 sends a response message corresponding to a request message to the web browser when identification information of the web browser satisfies a predetermined reference.

The predetermined reference is preset between the system 100 and the web browser, and may be sent from the web browser in advance.

Since a response message is sent only to a web browser that sends identification information that satisfies the predetermined reference among connected web browsers, a secure HTTP communication can be implemented even when session key information is leaked.

The present invention discloses a concept of an one time request (OTR). The OTR indicates a function to allow already-used information not to be re-used. The OTR also indicates a function to allow a request having processed by the web browser not to be processed by the web server.

Accordingly, in the present invention, when the same request message is sent from the same web browser, a response message is not repeatedly sent from the web server.

The program sending unit 130 sends a computer program including identification information in a request message of the web browser to a terminal where the web browser is executed. Accordingly, a user having no professional knowledge for secure communication can easily utilize the secure communication.

The request message body decoding unit 140 decodes an encrypted body of the request message sent from the web browser, and the response message body encrypting unit 150 encrypts a body of the response message sent to the web browser.

A basic communication standard on the web, an HTTP is not provided with a standard relevant to an encryption/decoding, thereby having a weak security. In order to solve the problem, an HTTPS (secure) has been provided to enhance a security function. That is, the HTTPS is a standard implemented by adding a security function to the HTTP.

In order to use the HTTPS, a certification has to be issued from a server certificate authority thus to be installed on the web server. Herein, an issuing cost according to a unit is required every year. Accordingly, a small market that manages a general web server does not utilize the issued certification due to a large cost and a complex installation process for the server certificate.

As an encryption function of the relay program is used in the present invention, a security function in the HTTP can be enhanced to the HTTPS, thereby simplifying the installation process.

Furthermore, in the conventional art, a verification period is limited into an annual period, and only a security level authorized by a server certificate is used. However, in the present invention using the relay program, more enhanced security level may be immediately applied. Also, a verification period may be arbitrarily controlled.

In case of the HTTPS, a verification for the web server and a security for exchanging data are regarded to be more important rather than a verification for a user. Accordingly, a verification for the user is deficient. That is, the conventional HTTPS is a uni-directional verification.

However, in the present invention, the relay program is provided with a user's verification process using a user's certificate. Accordingly, a bi-directional verification is possible thus to enhance a security function.

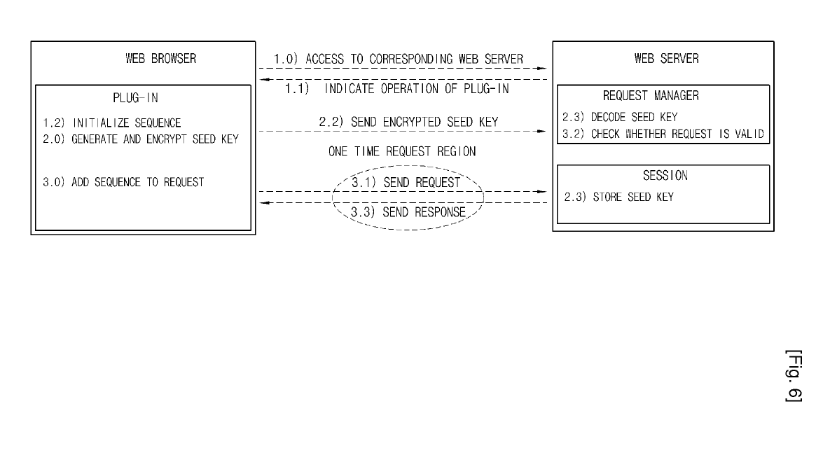

FIG. 5 is a block diagram schematically showing a system for a secure communication according to another embodiment of the present invention.

Referring to FIG. 5, a system 200 for a secure communication may be implemented as a relay program, and comprises an identification information generating unit 210, an identification information inserting unit 220, an encryption key sending unit 230, a request message body encrypting unit 240, and a response message body decoding unit 250.

The identification information generating unit 210 generates identification information of a request message when the web browser accesses to the web server, and the identification information inserting unit 220 inserts identification information to the request message sent to the web server by the web browser. Herein, the identification information is inserted after being encrypted.

Since identification information of each web browser is sent to the web server, the web server sends a response message only to a web browser that sends identification information that satisfies a predetermined reference. Accordingly, a secure HTTP communication can be implemented even when session key information is leaked.

The encryption key sending unit 230 sends an encryption key for decoding encrypted identification information to the web server. Herein, the encryption key is encrypted by using a public key of the web server.

The system for a secure communication 200 is implemented as a computer program, and the computer program may be sent from the web server.

The request message body encrypting unit 240 encrypts a body of a request message sent to the web server, and the response message body decoding unit 250 decodes an encrypted body of a response message sent from the web server.

Other methods for preventing interruption of a secure communication due to leakage of session key information includes the followings.

First, there is a method for preventing session key information from leaking. The method is used in most of sites having an enhanced security function. According to the method, searching a session key by using a hidden cookie, etc. is made to be difficult, and leaking session key information from a mail, a bulletin, a blog, etc. is made to be difficult.

However, a secure communication can not be implemented just by making leakage of the session key information be difficult. The session key information may be leaked by other techniques.

Second, there is a method for checking a computer having sent a request message by storing an IP of the computer having a web browser being executed in a session.

However, there is also a limitation in checking the IP. A session can not be maintained in an environment such as a large company where the IP is dynamically changed by using an NAT equipment. The reason is because the web server can implement a specific action by using an IP spoofing that deceives an IP.

In the present invention, a request is used one time but is not re-used. Since a single request is not re-used even if session key information is leaked, the conventional problem due to the leakage can be solved.

A request message sent by a corresponding browser on the HTTP includes specific information of the browser. Accordingly, the web server recognizes/verifies/identifies the web browser having sent the request message, and judges whether the request message can be usable.

The web browser adds its own specific information to a header of each request message sent to the web server. The web server extracts specific information of the browser from the header of the received request message, thereby judging whether the information is valid and usable.

FIG. 6 is a diagram showing a method for a secure communication according to one embodiment of the present invention.

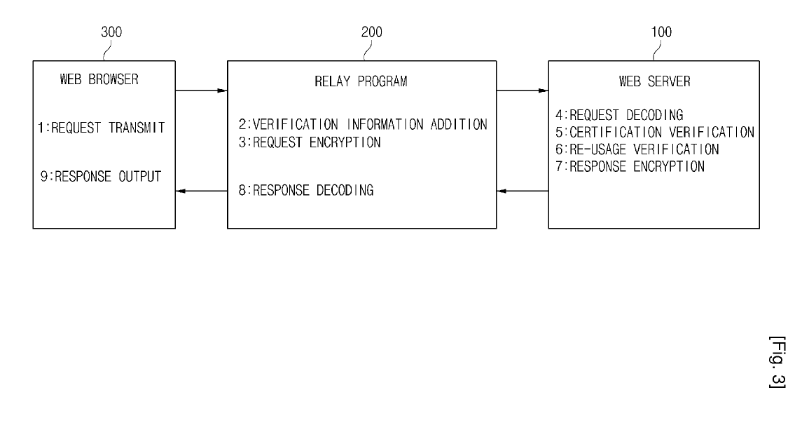

Referring to 2.0) of FIG. 2, a plug-in arbitrarily generates a key to encrypt sequence information, and encrypts by using a public key of a web server, thereby sending the key to the web server. Referring to 2.3), the web server decodes the received key by using a private key thus to store an encryption key in a session.

Referring to 3.0), the plug-in encrypts the sequence information by using the generated key thus to add to a request. Referring to 3.2), the web server decodes the encrypted sequence information by using the encryption key stored in the session, and judges whether the information is valid and usable.

The encryption key includes a public key of the web server, a private key of the web server, and a sequence encryption key. The sequence encryption key is arbitrarily generated, and is shared only between the web browser and the web server. The sequence encryption key can be shared after being encrypted/decoded by the public key of the web server and the private key of the web server.

Referring to FIG. 6, a plug-in program operated by depending on the web browser performs a secure communication between the web server and the web browser. However, referring to FIG. 3, a relay program independently operated from the web browser performs a secure communication between the web server and the web browser.

Concrete process flow is as follows.

1. Initialize

Once the web browser initially accesses to the corresponding web server, a plug-in is operated. The plug-in initializes a sequence number to be allocated according to each request.

2. Negotiation

The plug-in arbitrarily generates an encrypted seed key at a starting time point, and encrypts (RSA) the key by using the public key of the web server thus to send to the web server. Then, the web server decodes the encrypted seed key by using the private key thereof, and stores the key in a session, etc. The web server and the plug-in may request new negotiation information if necessary, but requires previous negotiation information.

3. Send Request

The plug-in mounted on the web browser increases a sequence number whenever sending a request to the corresponding web server. The web browser encrypts the sequence number, a random value, and a HASH value thereof by using a seed key, thereby adding to the header of the request.

4. Verify Request

The web server extracts an encryption value from the header of the request, and decodes the encryption value by using the seed key stored in the session. Then, the web server checks whether the request is valid by checking a HASH from the decoded data, and judges whether the request can be re-usable by checking an included sequence number. The web server informs whether the request can be reusable by managing a used sequence number in a proper manner.

5. Finalize

When the session is finalized, operation of the plug-in of the web browser is stopped. Herein, the web server abandons negotiation information and sequence information stored in the session.

1. A system for a secure communication, comprising:
an identification information extracting unit for extracting identification information from a request message sent from a web browser; and
a response message sending unit for sending a response message corresponding to the request message to the web browser when the identification information satisfies a predetermined reference.

2. The system of claim 1, wherein the identification information extracting unit comprises:
an encryption value extracting unit for extracting an encryption value of identification information from the request message; and
a decoding unit for decoding the extracted encryption value.

3. The system of claim 2, wherein the decoding is performed by using an encryption key sent from the web browser.

4. The system of claim 3, wherein the encryption key is encrypted by using a public key of a web server.

5. The system of claim 4, further comprising a program sending unit for sending a computer program including the identification information in the request message of the web browser to a terminal where the web browser is executed.

6. The system of claim 5, further comprising a request message body decoding unit for decoding an encrypted body of the request message sent from the web browser.

7. The system of claim 5, further comprising a response message body encrypting unit for encrypting a body of the response message sent to the web browser.

8. A system for a secure communication, comprising:
an identification information generating unit for generating identification information of a request message when a web browser accesses to a web server; and
an identification information inserting unit for inserting the identification information to the request message sent to the web server by the web browser.

9. The system of claim 8, wherein the identification information inserting unit inserts the identification information after an encryption.

10. The system of claim 9, further comprising an encryption key sending unit for sending an encryption key for decoding the encrypted identification information to the web server.

11. The system of claim 10, wherein the encryption key is encrypted by using a public key of the web server.

12. The system of claim 11, wherein the system for a secure communication is implemented as a computer program, and the computer program is sent from the web server.

13. The system of claim 12, further comprising a request message body encoding unit for encoding a body of the request message sent to the web server.

14. The system of claim 12, further comprising a response message body decoding unit for decoding an encrypted body of the response message sent from the web server.

15. A method for a secure communication, comprising:
extracting identification information from a request message sent from a web browser by a web server; and
sending a response message corresponding to the request message to the web browser when the identification information satisfies a predetermined reference.

16. The method of claim 15, wherein the extracting identification information comprises:
extracting an encryption value of the identification information from the request message; and
decoding the extracted encryption value.

17. The method of claim 16, wherein the decoding is performed by using an encryption key sent from the web browser.

18. The method of claim 17, wherein the encryption key is encrypted by using a public key of the web server.

19. The method of claim 18, further comprising sending a computer program including the identification information in the request message of the web browser to a terminal where the web browser is executed.

20. The method of claim 19, further comprising decoding an encrypted body of the request message sent from the web browser.

21. The method of claim 19, further comprising a response message body encrypting unit for encrypting a body of the response message sent to the web browser.

22. A method for a secure communication, comprising:
generating identification information of a request message when a web browser accesses to a web server by a computer program on a terminal where the web browser is executed; and
inserting the identification information to the request message sent to the web server by the web browser by the computer program.

23. The method of claim 22, wherein the identification information is inserted after being encrypted.

24. The method of claim 23, wherein the web browser sends an encryption key for decoding the encrypted identification information to the web server.

25. The method of claim 24, wherein the encryption key is encrypted by using a public key of the web server.

26. The method of claim 25, wherein the computer program is sent from the web server.

27. The method of claim 26, further comprising encoding a body of the request message sent to the web server.

28. The method of claim 26, further comprising decoding an encrypted body of a response message sent from the web server.

29. A computer program for executing a method for a secure communication,
the method comprising:
extracting identification information from a request message sent from a web browser by a web server; and
sending a response message corresponding to the request message to the web browser when the identification information satisfies a predetermined reference.

30. The system for a secure communication of claim 5, wherein the computer program is independently executed from the web browser.

31. The system of claim 5, wherein the computer program is executed by depending on the web browser.

32. The system of claim 12, wherein the computer program is independently executed from the web browser,

33. The system of claim 12, wherein the computer program is executed by depending on the web browser.

34. The method of claim 19, wherein the computer program is independently executed from the web browser.

35. The method of claim 19, wherein the computer program is executed by depending on the web browser.

36. The method of claim 22, wherein the computer program is independently executed from the web browser.

37. The method of claim 22, wherein the computer program is executed by depending on the web browser.

38. A computer program for executing a method for a secure communication,
the method comprising:
generating identification information of a request message when a web browser accesses to a web server by a computer program on a terminal where the web browser is executed; and
inserting the identification information to the request message sent to the web server by the web browser by the computer program.
